(19) United States
(12) Patent Application Publication
(10) Pub. No.: US 2015/0200524 A1
(43) Pub. Date: Jul. 16, 2015

(54) Modular power distribution for a tactical vehicle

(71) Applicants: John M. Seel, King George, VA (US); Robert J. Dibble, King George, VA (US); F. Michael Ryan, King George, VA (US); Timothy M. Brown, Locust Grove, VA (US)

(72) Inventors: John M. Seel, King George, VA (US); Robert J. Dibble, King George, VA (US); F. Michael Ryan, King George, VA (US); Timothy M. Brown, Locust Grove, VA (US)

(73) Assignee: United States Government, as represented by the Secretary of the Navy, Arlington, VA (US)

(21) Appl. No.: 13/373,249

(22) Filed: Oct. 31, 2011

(51) Int. Cl. H02B 1/04; H04B 1/16

(52) U.S. Cl. CPC H02B 1/04; H04B 1/1607

(57) ABSTRACT

A modular power distribution system is provided for a tactical vehicle. The system includes a connector panel disposed within an attachment plate configured to be mounted to an interior surface of the tactical vehicle, a plurality of interface units disposed within the connector panel, and a plurality of signal source units corresponding to the interface units and accessible therefrom. The signal source units include at least one power supply unit and other signal source units each configured to supply signals via corresponding interfaces when connected to external electronic devices. A circuit breaker is also provided and includes a corresponding interface unit of the plurality of interface units and is connected with the power supply unit, and configured to connect and disconnect power supply to the modular power distribution system, from the tactical vehicle

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to a power distribution system. In particular, the invention relates to a modular power distribution system enabling the distribution of power signals and other signals such as Ethernet signals, coaxial signals and Global Positioning System (GPS) signals via a single unit installed within a tactical vehicle.

Tactical vehicles are typically used in a military environment, and require specialized capabilities to be accessible by the driver or passenger (e.g. assistant driver) such as power and data accesses for computer usage, for example, and GPS and video capabilities in order to perform necessary tasks.

These vehicles typically include a unique installation kit, including wiring and brackets, for example, for installing a radio or other electronic equipment therein. However, there may be some problems associated with the integration of new electronic equipment post-manufacturing, into these vehicles. New electronic equipment may be required to be attached directly to a power bus assembly of the vehicle, and therefore it may be time-consuming to complete the integration thereof. In addition, wiring harnesses and fittings are typically required to be cut based on vehicle type which results in several different types of harnesses and fittings being manufactured based upon the vehicle types. In addition, any vehicle requiring GPS capabilities may require additional wiring in order to be integrated therein.

It is desirable to have a modular power distribution system for vehicles which provides connections for distribution of power and other signals via a single unit having a set of interfaces, and thereby reduce costs and time associated with the installation of electronic equipment.

### SUMMARY

Conventional power distribution arrangements yield disadvantages addressed by various exemplary embodiments of the present invention. The present invention obviates the above-mentioned problems by providing a modular power distribution system which provides a set of interfaces via a signal connector panel for distributing power and other signals (e.g., Ethernet, Coax signals, and GPS signals) within a tactical vehicle.

Various exemplary embodiments provide a modular power distribution system for a tactical vehicle. The system includes a connector panel disposed within an attachment plate configured to be mounted to an interior surface of the tactical vehicle, a plurality of interface units disposed within the connector panel, and a plurality of signal source units corresponding to the interface units and accessible therefrom. The signal source units include at least one power source unit and other signal source units each configured to supply signals via corresponding interfaces when connected to external electronic devices. A circuit breaker is also provided and includes a corresponding interface unit of the plurality of interface units and is connected with the power supply unit, and configured to connect and disconnect power supply to the modular power distribution system, from the tactical vehicle.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a diagram illustrating a front view of the modular power distribution system that may be implemented within various embodiments;

FIG. 2 is a block diagram illustrating components included within the modular power distribution system that may be implemented within embodiments of the present invention;

FIG. 3 is a block diagram illustrating a connection between the components of the modular power distribution system as shown in FIG. 2 and components of the tactical vehicle;

FIG. 4A is a diagram illustrating a connector panel of the modular power distribution system shown in FIG. 1;

FIG. 4B is a diagram illustrating an attachment plate of the modular power distribution system shown in FIG. 1; and

FIG. 5 is a a diagram of a cover plate of the modular power distribution system shown in FIG. 1.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

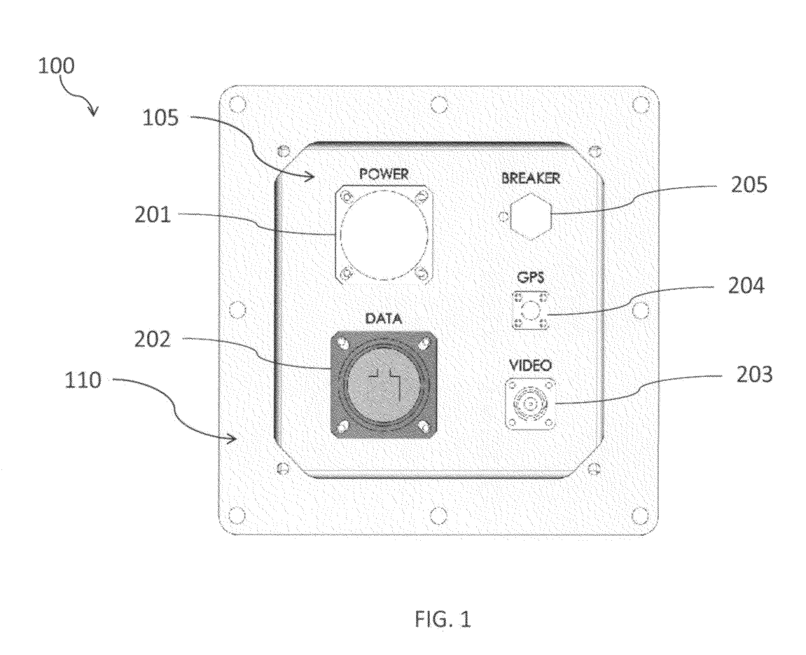

FIG. 1 shows an embodiment, providing a modular power distribution system 100 in a standard outlet configuration, having physical connections directly installed in a vehicle for example, a tactical vehicle such as a tank, fighting vehicles, logistics vehicles, boats, robotic systems for military use. For illustration purposes only, embodiments will be discussed in reference to tactical vehicles however the present invention is not limited hereto and may be applied to non-tactical vehicles such as agricultural machinery, trucks, and boats, for example.

With reference now to the figures, FIG. 1 is a diagram illustrating a front view of the modular power distribution system that may be implemented within embodiments of the present invention. As shown in FIG. 1, the modular power distribution system 100 is for a tactical vehicle (not shown). The system 100 includes a connector panel 105 disposed within an attachment plate 110 and is configured to be mounted to an interior surface of the tactical vehicle. For example, the system 100 may be mounted within a console at the center of the tactical vehicle or within the dashboard.

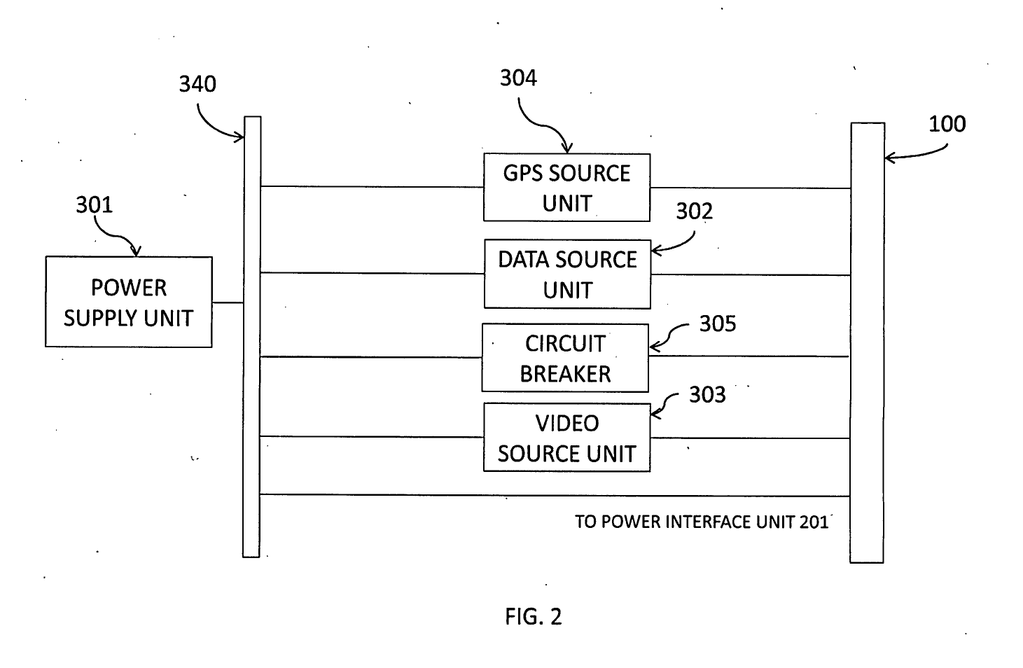

As shown in FIG. 1, according to an embodiment of the present invention, the system 100 further includes a plurality of interface units 201 through 205 disposed within the connector panel 105. The plurality of interface units include a power interface unit 201, a data interface unit 202, a video interface unit 203 and a GPS interface unit 204, for example. These interface units enable the distribution of power, and other signals, for the driver when desired. The driver is able to integrate additional electronic devices when necessary in order to complete tasks. A circuit breaker interface unit 205 is also provided to allow for manual operation of a circuit breaker 305 (depicted in FIG. 2) in order to immediately disconnect power to the system 100, when necessary. Additional details regarding the circuit breaker 305 and other components of the system 100 will be discussed below. The invention is not limited to any particular number or type of interfaces and may vary as needed.

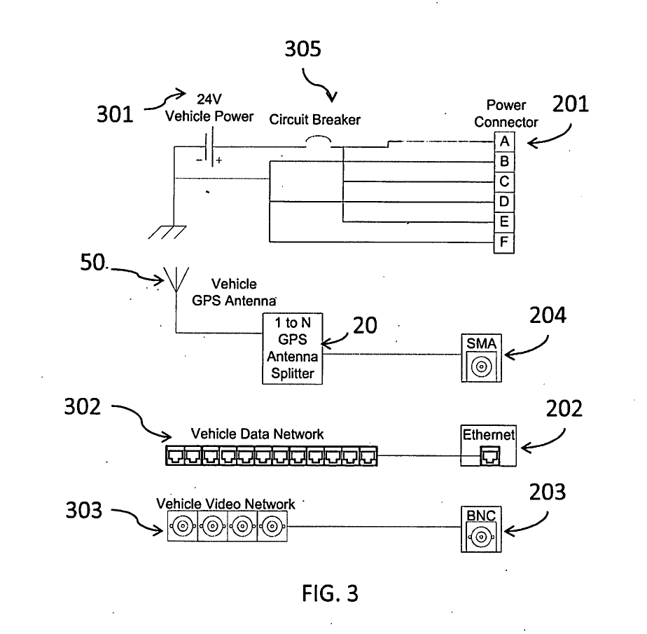

FIG. 1 is a block diagram illustrating components included within the modular power distribution system that may be implemented within embodiments of the present invention; and FIG. 3 is a block diagram illustrating a connection between the components of the modular power distribution system as shown in FIG. 2, and components of the tactical vehicle that can be implemented within embodiments of the present invention.

As shown in FIG. 2, the system 100 further includes a plurality of signal source units 301 through 304 respectively corresponding to interface units 201 through 204. The signal source units include a power supply unit 301, a data source unit 302, a video source unit 303 and a GPS unit 304. As shown in FIG. 3, these signal source units 301 through 304 correspond to respective interface units 201 through 204 and are accessible therefrom. According to an embodiment of the present invention, the power supply unit 301 is the main power supply of the vehicle (e.g., the vehicle battery).

Further, referring back to FIG. 2, the signal source units 301 through 304 each supply signals via their corresponding interface units 201 through 204 when connected to external electronic devices, for example, a computer (not shown). Details regarding each signal source unit 301 through 304 will be discussed.

According to an embodiment of the present invention, the power supply unit 301 is configured to supply power to the power interface unit 201 at a range of approximately 18 volts to approximately 32 volts DC as supplied by the tactical vehicle. According to an embodiment of the present invention, as shown in FIG. 3, the data source unit 302 is configured for data acquisition and transmission and provides a connection to a communication network such as the Internet to supply data signals.

The data interface unit 202 may be connected to the data source unit 202 via a data signal adapter (e.g., an Ethernet adapter) adaptable for harsh environments and including a plug which seals against fluids and dusts and is shock, vibration and tract resistant. For example, the data source unit 302 may include an RJFTV adapter enables the use of an Ethernet class D/Category 5e connection. According to an embodiment of the present invention, the data source unit 302 also does not require on-field cabling or grounding. The present invention is not limited to the use of Ethernet and may vary accordingly.

According to an exemplary embodiment, the video source unit 303 is connected with a coaxial adapter, for example, at the video interface unit 203 using coaxial cables, for example, and provides video signals to a computer (not shown) which may be connected to the power supply unit 301 of the system 100 via the power interface unit 201. Further, as shown in FIGS. 2 and 3, the GPS source unit 304 is includes a receiver (not shown) and an antenna splitter 20 and is configured to be connected to and receive GPS signals from a Vehicle GPS antenna 50, at the GPS interface unit 204 disposed at the connector panel 105 (depicted in FIG. 1).

Further, as shown in FIG. 2, the circuit breaker 305 is connected with the power supply unit 301. The data source unit 302, the video source unit 303, the GPS source unit 304 and the circuit breaker 305 may be connected to the power supply unit 301 of the tactical vehicle via a power bus assembly 340. As shown in FIG. 3, the circuit breaker 305 may be directly connected with the power supply unit 301. The circuit breaker 305 connects and disconnects power supply to the modular power distribution system, from the power supply unit 301 when necessary. According to an embodiment of the present invention, the power supply is disconnected from the main power supply unit 350 when it exceeds a circuit breaker rating of approximately 30 amperes to 90 amperes.

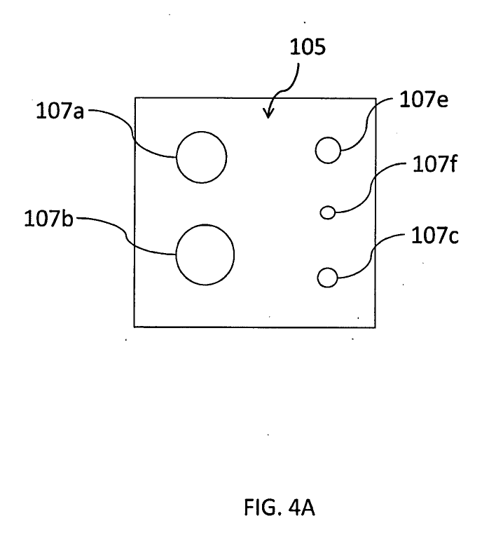

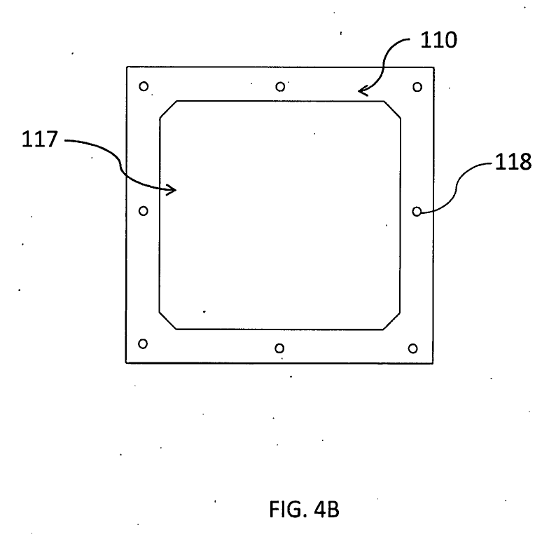

Details regarding the connector panel 105 and attachment plate 110 of the power distribution system 100 will now be discussed with reference to FIGS. 4A and 4B, which are diagrams illustrating a connector panel and attachment plate, respectively of the modular power distribution system shown in FIG. 1 that can be implemented within embodiments of the present invention.

As shown in FIG. 4A, the connector panel 105 includes a plurality of through-holes 107a through 107e which correspond to the interface units 201 through 205, respectively. Thus, the through-holes 107a through 107e are formed of any suitable size to correspond to the interface units 201 through 205 respectively. According to an embodiment of the present invention, the connector panel 105 is formed of a metallic material such as steel or any other suitable material. The connector panel 105 is inserted into and mounted within the attachment plate 110 as shown in FIG. 4B.

According to an exemplary embodiment, the attachment plate 110 includes a through-hole 117 for receiving the connector panel 105 therein. The attachment plate 110 further includes hole portions 118 for securing the attachment plate 110 and connector panel 105 to the interior surface of the tactical vehicle via an attaching means such as bolts or screws. According to an embodiment of the present invention, the attachment plate 110 is formed of the same material as that of the connector panel 105. According to other embodiments, the attachment plate 110 may be formed of a different material than that of the connector plate 105. According to an exemplary embodiment of, a cover plate may also be provided to protect the modular power distribution system 100 when not in use.

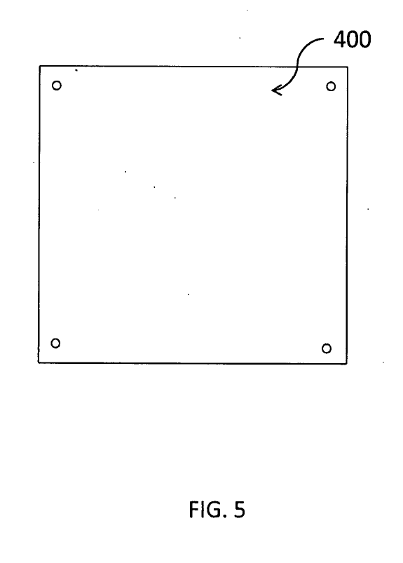

FIG. 5 is a diagram of a cover plate of the modular power distribution system shown in FIG. 1 that can be implemented within embodiments of the present invention. As shown in FIG. 5, a cover plate 400 is provide and is attached to a front surface of the modular power distribution system 100 via an attaching means (not shown).

Embodiments of the present invention provide a modular power distribution system mountable within any tactical vehicle and including a set of interfaces via a single connector panel which enables the distribution of power signals and other signals such as Ethernet signals, coax signals and GPS signals. Thus, various exemplary embodiments reduce costs and time associated with integrating new electronic equipment within the tactical vehicle after manufacturing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A modular power distribution system for a tactical vehicle having a power supply unit for supplying electrical power, the system comprising:
a connector panel disposed within an attachment plate for mounting to an interior surface of the tactical vehicle;
a plurality of interface units disposed within the connector panel;
a circuit breaker having a corresponding circuit breaker interface unit of the plurality of interface units and connected to the power supply unit to alternately connect and disconnect the modular power distribution system to and from the power supply in the tactical vehicle:
a plurality of primary signal source units, each primary signal source unit corresponding to a respective interface unit of the plurality of interface units and accessible therefrom; and
a plurality of secondary signal source units, each secondary signal unit supplying signals in response to an external electronic
device connected thereto, and corresponding to the respective primary signal source unit that connect to the respective interface unit of the plurality of interface unit.

2. The modular power distribution system of claim 1, wherein the power supply unit is a vehicle battery of the tactical vehicle.

3. The modular power distribution system of claim 1, wherein the each secondary signal source unit includes at least one of the group consisting of: a data source unit configured to supply data signals for connection to a communication network, a video source unit configured to supply video signals, and a global positioning system (GPS) source unit configured to distribute GPS signals.

4. The modular power distribution system of claim 1, wherein the plurality of primary signal source units receives electrical power via a power bus assembly connected with the power supply unit of the tactical vehicle.

5. The modular power distribution system of claim 1, wherein the plurality of secondary signal source units includes a data source unit connected to an Ethernet adapter at a corresponding adapter interface unit.

6. The modular power distribution system of claim 3, wherein the power supply unit supplies electrical power via corresponding power supply interface unit at a range of approximately 18 volts to approximately 32 volts DC as supplied by the tactical vehicle.

7. The modular power distribution system of claim 6, wherein the circuit breaker disconnects power supplied to the modular power distribution system in response to exceeding a circuit breaker rating between approximately 30 amperes to approximately 90 amperes.

8. The modular power distribution system of claim 7, wherein the circuit breaker interface unit performs manual operation of the circuit breaker.

9. The modular power distribution system of claim 1, wherein the plurality of secondary signal source units includes a video source unit connected to a coaxial adapter at a corresponding video interface unit.

10. The modular power distribution system of claim 1, wherein the the plurality of secondary signal source units includes a GPS source unit with an antenna splitter and connects to and receives GPS signals from a GPS antenna in the tactical vehicle, at a corresponding GPS interface unit.
